(19) United States
(12) Patent Application Publication
(10) Pub. No.: US 2014/0185528 A1
(43) Pub. Date: Jul. 3, 2014

(54) TERMINAL, BASE STATION, COMMUNICATION SYSTEM, AND COMMUNICATION METHOD

(71) Applicants: Kazuyuki Shimezawa, Osaka-shi (JP); Kimihiko Imamura, Osaka-shi (JP); Toshizo Nogami, Osaka-shi (JP)

(72) Inventors: Kazuyuki Shimezawa, Osaka-shi (JP); Kimihiko Imamura, Osaka-shi (JP); Toshizo Nogami, Osaka-shi (JP)

(73) Assignee: SHARP KABUSHIKI KAISHA, Osaka-shi, Osaka (JP)

(21) Appl. No.: 14/238,392

(22) PCT Filed: Aug. 7, 2012
(86) PCT No.: PCT/JP2012/070068

§ 371 Date: Feb. 11, 2014

(30) Foreign Application Priority Data
Aug. 12, 2011 (JP) 2011-176623

(51) Int. Cl. H04B 7/06

(52) U.S. Cl. CPC H04B 7/0626
USPC 370/328

(57) ABSTRACT

There are provided a terminal, a base station, a communication system, and a communication method allowing a base station to efficiently notify a terminal of control information in a communication system in which the base station and the terminal communicate with each other. A terminal configured to communicate with a base station including a plurality of transmit antenna ports is configured to estimate, based on a channel state information reference signal transmitted from the plurality of transmit antenna ports, a channel state between the base station and the terminal; and to generate power difference information representing a difference between powers for groups of transmit antenna ports that are some of the plurality of transmit antenna ports.

### TECHNICAL FIELD

The present invention relates to a terminal, a base station, a communication system, and a communication method.

### BACKGROUND ART

In wireless communication systems such as WCDMA (Wideband Code Division Multiple Access), LTE (Long Term Evolution), and LTE-A (LTE-Advanced) developed by 3GPP (Third Generation Partnership Project) and IEEE 802.11 and WiMAX (Worldwide Interoperability for Microwave Access) developed by IEEE (The Institute of Electrical and Electronics engineers), a base station (transmission point, cell, transmit station, transmitter, or eNodeB) and a terminal (mobile terminal, receive station, mobile station, receiver, or UE (User Equipment)) each include a plurality of transmit/receive antennas, and spatially multiplex data signals by using the MIMO (Multi Input Multi Output) technology to realize high-speed data communication.

In such wireless communication systems, a channel state between a base station and a terminal is measured using a channel state information reference signal (CSI-RS (Channel State Information-Reference Signal), pilot signal, or known signal) including signals known to both the base station and the terminal. Based on the measurement result, the wireless communication systems adaptively control the modulation scheme and coding rate (MCS: Modulation and Coding Scheme), the number of spatial multiplexing (number of layers or rank), precoding processing (precoding matrix or precoding weight), and so forth, thereby being able to realize more efficient data transmission.

FIG. 11 is a block diagram illustrating an example of performing adaptive control for the downlink (downlink line) on which data is transmitted from a base station to a terminal. In a base station 1100, a multiplexing unit 1102 maps a base-station-specific channel state information reference signal (RS (Reference Signal), pilot signal, or known signal) to physical resources, and transmits the resulting signal from a transmit antenna 1103. The channel state information reference signal transmitted by the base station 1100 is received by a terminal 1110 via downlink 1120. In the terminal 1110, a demultiplexing unit 1112 separates the channel state information reference signal from a signal received by a receive antenna 1111. Based on the channel state information reference signal, a feedback information generation unit 1113 measures a channel state on the downlink line 1120, and generates feedback information to be used to adaptively control the modulation scheme and coding rate, the number of spatial multiplexing, the precoding processing, and so forth. The generated feedback information is transmitted from a transmit antenna 1114, and is received by the base station 1100 via uplink (uplink line) 1121. In the base station 1100, a feedback information processing unit 1105 identifies the feedback information transmitted by the terminal 1110 from a signal received by a receive antenna 1104, and processes the feedback information. Based on the received feedback information, an adaptive control unit 1101 adaptively controls data signals to be transmitted to the terminal 1110. For adaptive control such as the one described above, a method described in NPL 1 below, for example, can be used.

Wireless communication systems employing a heterogeneous network configuration which includes a transmission point having wide coverage (communication area) and a transmission point having coverage narrower than the wide coverage can be constructed. Here, a transmission point refers to a set of transmit antennas arranged at a geographically (spatially) same location. For example, a transmission point refers to a base station, a cell, a sector, an RRH (Remote Radio Head), or a remote antenna. FIG. 12 is a schematic diagram of a wireless communication system that employs a heterogeneous network configuration. In an example illustrated in FIG. 12, a transmission point 1201, a transmission point 1202, and a transmission point 1203 construct a heterogeneous network configuration. The transmission point 1201, the transmission point 1202, and the transmission point 1203 form coverage 1205, coverage 1206, and coverage 1207, respectively. Also, the transmission point 1201 is connected to the transmission point 1202 via a line 1208 and to the transmission point 1203 via a line 1209. This configuration allows the transmission point 1201 to transmit and receive control signals and data signals to and from the transmission point 1202 and the transmission point 1203. As each of the lines 1208 and 1209, a wired line such as an optical fiber or the like and/or a wireless line using a relay technology can be used. In this state, by configuring the transmission point 1201, the transmission point 1202, and the transmission point 1203 to use partially or entirely the same frequencies (resources), the overall spectral efficiency (transmission capacity) within an area of the coverage 1205 can be improved.

While being located within the coverage 1206, a terminal 1204 is able to perform single-cell communication with the transmission point 1202. When being located near the edge (cell edge) of the coverage 1206, some measures are needed against co-channel interference from the transmission point 1201. There has been proposed a method for reducing or suppressing interference on the terminal 1204 in a cell-edge area by performing, as cooperative communication (CoMP (Coordinated Multipoint) communication or multi-cell communication) between the transmission point 1201 and the transmission point 1202, base station cooperative communication in which neighboring base stations cooperate with each other. For cooperative communication such as the one described above, a method described in NPL 2 below, for example, has been proposed.

A cell ID is an ID (identification) unique to a cell indentified by a terminal. The transmission point 1201, the transmission point 1202, and the transmission point 1203 capable of performing cooperative communication may be configured to have the same cell ID or different cell IDs. In the case where transmission points capable of performing cooperative communication are configured to have the same cell ID, the terminal 1204 is no longer required to perform handover processing while being located within the coverage 1205 in a system in which handover control is performed based on the cell ID. Consequently, seamless data communication can be realized. In the case where transmission points capable of performing cooperative communication are configured to have different cell IDs, the terminal 1204 is able to recognize each of the transmission points as an independent cell. For such cooperative communication, a method described in NPL 3 below, for example, has been proposed.

### CITATION LIST

### Patent Literature

### Non Patent Literature

NPL 1: 3rd Generation Partnership Project; Technical Specification Group Radio Access Network; Evolved Universal Terrestrial Radio Access (E-UTRA); Physical layer procedures (Release 10), 3GPP TS 36.213 V10.2.0 (2011-06).
NPL 2: 3rd Generation Partnership Project; Technical Specification Group Radio Access Network; Further Advancements for E-UTRA Physical Layer Aspects (Release 9), March 2010, 3GPP TR 36.814 V9.0.0 (2010-03).
NPL 3: NTT DOCOMO, “CoMP with Lower Tx Power RRH in Heterogeneous Network,” R1-110867, 3GPP TSG-RAN WG1 #64, February 2011.

### SUMMARY OF INVENTION

### Technical Problem

However, in the case where a plurality of base stations (transmission points) perform cooperative communication with a terminal in a heterogeneous network configuration, the power of a signal received by the terminal from one base station differs from the power of a signal received by the terminal from another base station. Because conventional communication systems do not take into consideration a difference between receive powers from base stations, the terminal is unable to generate preferable feedback information. Consequently, the base stations are unable to realize preferable adaptive control for the terminal, preventing improvement in transmission efficiency.

The present invention has been made in view of the above issue, and an object thereof is to provide a terminal, a base station, a communication system, and a communication method allowing a base station to efficiently realize adaptive control for a terminal in a communication system in which the base station and the terminal communicate with each other.

### Solution to Problem

(1) This invention has been made to overcome the above-described issue, and a terminal according to an embodiment of the present invention is a terminal configured to communicate with a base station including a plurality of transmit antenna ports. The terminal includes a channel estimation unit configured to estimate, based on a channel state information reference signal transmitted from the plurality of transmit antenna ports, a channel state between the base station and the terminal; and a feedback information generation unit configured to generate, based on the channel state, power difference information representing a difference between powers for groups of transmit antenna ports that are some of the plurality of transmit antenna ports.

(2) Also, a terminal according to an embodiment of the present invention is the above-described terminal, wherein the groups of transmit antenna ports are each constituted by transmit antenna ports predefined from among the plurality of transmit antenna ports.

(3) Also, a terminal according to an embodiment of the present invention is the above-described terminal, wherein the groups of transmit antenna ports are each constituted by transmit antenna ports which the terminal is notified of by the base station from among the plurality of transmit antenna ports.

(4) Also, a terminal according to an embodiment of the present invention is the above-described terminal, wherein the plurality of transmit antenna ports are transmit antenna ports configured to transmit the channel state information reference signal that is configured based on one piece of channel-state-information-reference-signal configuration information which the terminal is notified of by the base station.

(5) Also, a terminal according to an embodiment of the present invention is the above-described terminal, wherein the plurality of transmit antenna ports are transmit antenna ports configured to transmit the channel state information reference signal that is configured based on a plurality of pieces of channel-state-information-reference-signal configuration information which the terminal is notified of by the base station.

(6) Also, a terminal according to an embodiment of the present invention is the above-described terminal, wherein the groups of transmit antenna ports are each constituted by transmit antenna ports corresponding to a set of channel state information reference signals represented by a corresponding one of the pieces of channel-state-information-reference-signal configuration information.

(7) Also, a terminal according to an embodiment of the present invention is the above-described terminal, wherein the feedback information generation unit is configured to generate the power difference information representing a difference between powers for the groups of transmit antenna ports arranged at a spatially same location.

(8) Also, a terminal according to an embodiment of the present invention is the above-described terminal, wherein the power difference information is subsampled in accordance with feedback information different from the power difference information generated by the feedback information generation unit.

(9) Also, a terminal according to an embodiment of the present invention is the above-described terminal, wherein the power difference information is jointly coded with feedback information different from the power difference information generated by the feedback information generation unit.

(10) Also, a base station according to an embodiment of the present invention is a base station including a plurality of transmit antenna ports and configured to communicate with a terminal. The base station includes a channel-state-information-reference-signal generation unit configured to generate a channel state information reference signal that is a signal known to both the base station and the terminal; a transmit antenna configured to transmit the channel state information reference signal from the plurality of transmit antenna ports; and a feedback information processing unit configured to process feedback information that is recommended transmission format information transmitted from the terminal to the base station. The feedback information is generated, based on a channel state between the base station and the terminal that is estimated using the channel state information reference signal, the feedback information including power difference information representing a difference between powers for groups of transmit antenna ports that are some of the plurality of transmit antenna ports.

(11) Also, a base station according to an embodiment of the present invention is the above-described base station, wherein the channel state information reference signal is transmitted from the transmit antenna ports of a plurality of transmission points arranged at spatially different locations.

(12) Also, a communication system according to an embodiment of the present invention is a communication system in which a base station including a plurality of transmit antenna ports and a terminal communicate with each other. The base station includes a channel-state-information-reference-signal generation unit configured to generate a channel state information reference signal that is a signal known to both the base station and the terminal, a transmit antenna configured to transmit the channel state information reference signal from the plurality of transmit antenna ports, and a feedback information processing unit configured to process feedback information that is recommended transmission format information transmitted from the terminal to the base station. The terminal includes a channel estimation unit configured to estimate, based on the channel state information reference signal, a channel state between the base station and the terminal, and a feedback information generation unit configured to generate, based on the channel state, power difference information representing a difference between powers for groups of transmit antenna ports that are some of the plurality of transmit antenna ports.

(13) Also, a communication method according to an embodiment of the present invention is a communication method for a terminal configured to communicate with a base station including a plurality of transmit antenna ports. The communication method includes a step of estimating, based on a channel state information reference signal transmitted from the plurality of transmit antenna ports, a channel state between the base station and the terminal; and a step of generating, based on the channel state, power difference information representing a difference between powers for groups of transmit antenna ports that are some of the plurality of transmit antenna ports.

(14) Also, a communication method according to an embodiment of the present invention is a communication method for a base station including a plurality of transmit antenna ports and configured to communicate with a terminal. The communication method includes a step of generating a channel state information reference signal that is a signal known to both the base station and the terminal; transmitting the channel state information reference signal from the plurality of transmit antenna ports; and a step of processing feedback information that is recommended transmission format information transmitted from the terminal to the base station. The feedback information is generated, based on a channel state between the base station and the terminal that is estimated using the channel state information reference signal, the feedback information including power difference information representing a difference between powers for groups of transmit antenna ports that are some of the plurality of transmit antenna ports.

(15) Also, a communication method according to an embodiment of the present invention is a communication method for a communication system in which a base station including a plurality of transmit antenna ports and a terminal communicate with each other. The communication method includes a step of generating, by the base station, a channel state information reference signal that is a signal known to both the base station and the terminal; a step of transmitting, by the base station, the channel state information reference signal from the plurality of transmit antenna ports; a step of processing, by the base station, feedback information that is recommended transmission format information transmitted from the terminal to the base station; a step of estimating, by the terminal, based on the channel state information reference signal, a channel state between the base station and the terminal; and a step of generating, by the terminal, based on the channel state, power difference information representing a difference between powers for groups of transmit antenna ports that are some of the plurality of transmit antenna ports of the plurality of transmit antenna ports.

### Advantageous Effects of Invention

According to the present invention, a base station can efficiently realize adaptive control for a terminal in a communication system in which the base station and the terminal communicate with each other.

### BRIEF DESCRIPTION OF DRAWINGS

FIG. 1 is a diagram illustrating a schematic view of a case where a heterogeneous network configuration according to a first embodiment of the present invention is employed.

FIG. 2 is a schematic block diagram illustrating the configuration of a transmission point 101 according to the first embodiment of the present invention.

FIG. 3 is a schematic block diagram illustrating the configuration of a terminal 104 according to the first embodiment of the present invention.

FIG. 4 is a diagram illustrating an example of a resource block pair on which signals are mapped by the transmission point 101 and/or a transmission point 102.

FIG. 5 is a diagram illustrating a flow diagram for the transmission point 101, the transmission point 102, and the terminal 104.

FIG. 6 is a diagram illustrating a flow diagram of how the terminal 104 generates feedback information.

FIG. 7 is a diagram illustrating an example of power difference information used as feedback information.

FIG. 8 is a diagram illustrating an example of precoding matrix information for the number of layers of 1.

FIG. 9 is a diagram illustrating an example of power difference information to be subsampled in accordance with rank information.

FIG. 10 is a diagram illustrating an example of feedback information in which rank information and power difference information are jointly coded.

FIG. 11 is a block diagram illustrating an example of performing adaptive control for the downlink on which data is transmitted from a base station to a terminal.

FIG. 12 is a schematic diagram of a wireless communication system that employs a heterogeneous network configuration.

### DESCRIPTION OF EMBODIMENTS

An embodiment of the present invention will be described below. A communication system according to this embodiment includes a base station (transmitter, cell, transmission point, set of transmit antennas, set of transmit antenna ports, component carrier, or eNodeB) and a terminal (terminal device, mobile terminal, reception point, reception terminal, receiver, set of receive antennas, set of receive antenna ports, or UE).

A plurality of base stations (cells) construct a heterogeneous network configuration and are capable of performing cooperative communication with the terminal. In the heterogeneous network configuration, the plurality of base stations are configured to have the same cell ID or different cell IDs. Here, a cell ID is an ID (Identification) unique to a cell identified by a terminal. A terminal identifies individual cells using the corresponding cell IDs, and performs handover control based on the cell ID, for example. Accordingly, in the case where the plurality of base stations are configured to have the same cell ID, even if the plurality of base stations are arranged in geographically different locations, the terminal is able to recognize the plurality of base stations as a signal base station. Also, in the case where the plurality of base stations are configured to have different cell IDs, even if the terminal is connected to a base station associated with any of the cell IDs, the terminal is able to accept cooperative communication performed by the base station and another base station associated with a cell ID different from that of the base station. Further, even when cooperative communication is performed, the terminal can recognize that the terminal is communicating with a single base station without recognizing the cooperative communication.

Accordingly, hereinafter, a base station capable of performing cooperative communication is referred to as a “transmission point”. Here, a transmission point refers to a set of transmit antennas arranged at a geographically same location. For example, a transmission point refers to part or entirety of a base station, a cell, a sector, an RRH (Remote Radio Head), a remote antenna, or the like. The terminal receives a data signal and/or a control signal from one transmission point or a plurality of transmission points; however, the terminal is not necessarily required to recognize the transmission point(s). Specifically, even in the case where the terminal communicates with one transmission point or a plurality of transmission points, the terminal may recognize that it is communicating with one base station. Accordingly, hereinafter, one or a plurality of transmission points may be referred to as “one base station”. Also, a data signal and a control signal can be transmitted from different transmission points or different sets of transmission points, and can be configured for each terminal. A transmission point that transmits a control signal may be referred to as a “control signaling point”.

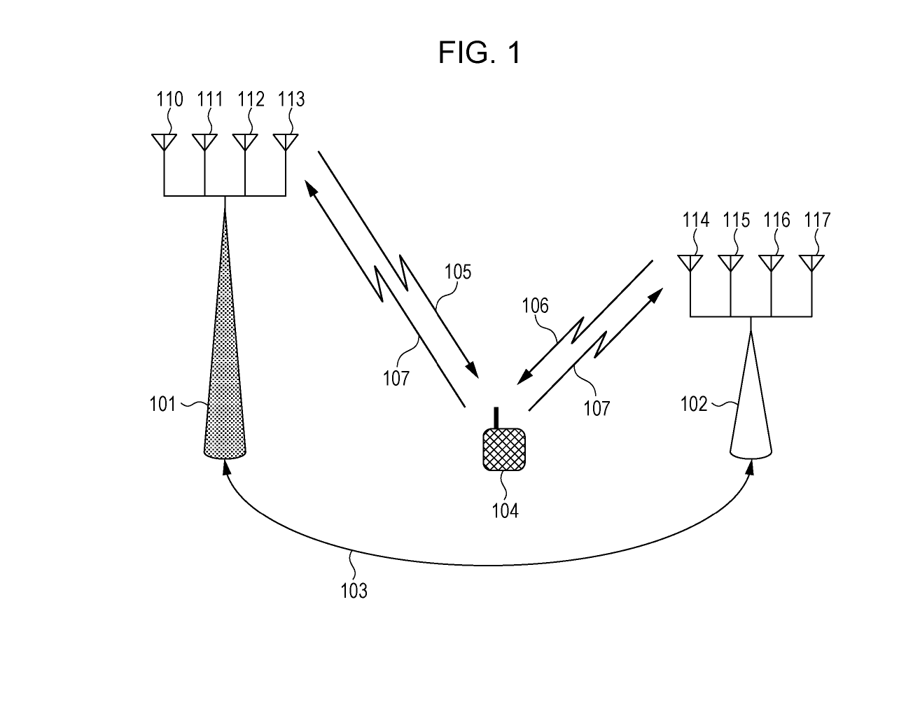

FIG. 1 is a diagram illustrating a schematic view of a case where the heterogeneous network configuration according to this embodiment is employed. Referring to FIG. 1, a transmission point 101 having wide coverage and a transmission point 102 having coverage narrower than the transmission point 101 perform cooperative communication with a terminal 104. Note that hereinafter the transmission point 101 is also referred to as a “first transmission point” and the transmission point 102 is also referred to as a “second transmission point”. The transmission point 101 and the transmission point 102 are connected to each other via a line 103 and are capable of performing communication of various kinds of control information, data signals addressed to the terminal 104, and so forth. As the line 103, a wired line such as an optical fiber and/or a wireless line using a relay technology may be used.

In an example illustrated in FIG. 1, the transmission point 101 includes four transmit antenna ports (a transmit antenna port 110, a transmit antenna port 111, a transmit antenna port 112, and a transmit antenna port 113) each configured to transmit a channel state information reference signal. The transmission point 102 includes four transmit antenna ports (a transmit antenna port 114, a transmit antenna port 115, a transmit antenna port 116, and a transmit antenna port 117) each configured to transmit a channel state information reference signal. Here, it is preferable that resources and/or sequences to which channel state information reference signals be mapped differ for different transmit antenna ports and be orthogonal or quasi-orthogonal to one another.

Also, a plurality of sets of channel state information reference signals for one or a plurality of transmit antenna ports are defined. Each set of channel state information reference signals is specified by channel-state-information-reference-signal configuration information. The terminal 104 is notified of one or a plurality of pieces of channel-state-information-reference-signal configuration information regarding channel state information reference signals used to generate feedback information for use in adaptive control, and one or a plurality of sets of channel state information reference signals are configured. In the case where transmission points capable of performing cooperative communication with the terminal 104 are configured to have either the same cell ID or different cell IDs, one or a plurality of sets of channel state information reference signals can be configured for the terminal 104. In the case where a plurality of sets of channel state information reference signals are configured, these sets of channel state information reference signals may be generated based on the same cell ID or the different cell IDs. Here, a set of channel state information reference signals is made up of channel state information reference signals for one, two, four, or eight antenna ports, the set being specified by channel-state-information-reference-signal configuration information. That is, one piece of channel-state-information-reference-signal configuration information specifies one, two, four or eight CSI ports.

In an example, one piece of configuration information of channel state information reference signals transmitted from eight transmit antenna ports (CSI (Channel State Information) ports 0 to 7) is configured for the terminal 104. The channel state information reference signals corresponding to CSI port 0 to CSI port 7 are respectively transmitted from the transmit antenna port 110 to the transmit antenna port 117. The channel state information reference signals corresponding to respective CSI ports are received by the terminal 104 via corresponding downlinks. Specifically, the channel state information reference signals corresponding to CSI ports 0 to 3 are received by the terminal 104 via downlink 105. The channel state information reference signals corresponding to CSI ports 4 to 7 are received by the terminal 104 via downlink 106.

At this time, depending on the location of the terminal 104, the terminal 104 possibly receives the channel state information reference signals having different receive powers from the transmission points. Specifically, depending on the location of the terminal 104, the channel state information reference signals corresponding to CSI ports 0 to 3 and received by the terminal 104 may differ from channel state information reference signals corresponding to CSI ports 4 to 7. The terminal 104 generates feedback information for use in adaptive control while taking into consideration the difference between receive powers from the transmission points or CSI ports, and notifies one transmission point or the set of transmission points of the feedback information via uplink 107.

In another example, two channel state information reference signals each for four transmit antenna ports (CSI (Channel State Information) ports 0 to 3) are configured for the terminal 104. It is preferable that the channel state information reference signals be configured to be orthogonal or quasi-orthogonal to each other. One of the channel state information reference signals corresponding to CSI port 0 to CSI port 3 is transmitted from the transmit antenna port 110 to the transmit antenna port 113, respectively, and the other of the channel state information reference signals corresponding to CSI port 0 to CSI port 3 is transmitted from the transmit antenna port 114 to the transmit antenna port 117, respectively. The channel state information reference signals corresponding to respective CSI ports are received by the terminal 104 via corresponding downlinks. Specifically, the channel state information reference signals corresponding to CSI ports 0 to 3 and transmitted from the transmission point 101 are received by the terminal 104 via the downlink 105. The channel state information reference signals corresponding to CSI ports 0 to 3 and transmitted from the transmission point 102 are received by the terminal 104 via the downlink 106.

At this time, depending on the location of the terminal 104, the terminal 104 possibly receives the channel state information reference signals having different receive powers from the transmission points. Specifically, depending on the location of the terminal 104, the channel state information reference signals corresponding to CSI ports 0 to 3, transmitted from the transmission point 101, and received by the terminal 104 may differ channel state information reference signals corresponding to CSI ports 0 to 3 and transmitted from the transmission point 102. The terminal 104 generates feedback information for use in adaptive control while taking into consideration the difference between receive powers from the transmission points, and notifies one transmission point or the set of transmission points of the feedback information via the uplink 107.

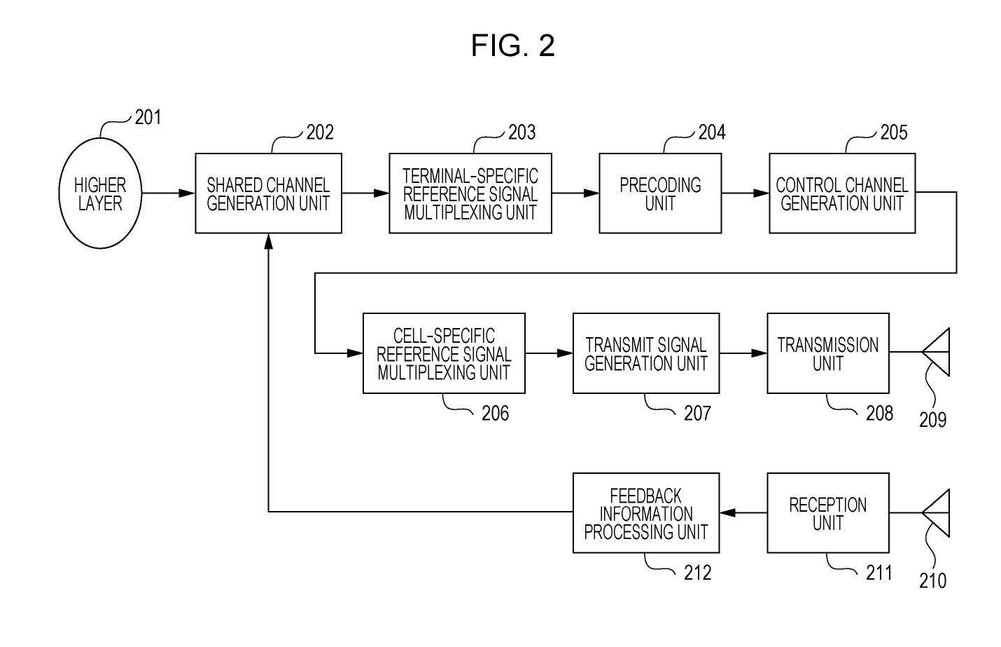

FIG. 2 is a schematic block diagram illustrating the configuration of the transmission point 101 according to this embodiment. Although the following description is regarding the transmission point 101, the transmission point 102 may have a configuration similar to that illustrated in FIG. 2. The following describes a case where the transmission point 101 performs scheduling processing and the like for the terminal 104, notifies the transmission point 102 of the result of the scheduling processing, and performs cooperative communication; however, the configuration is not limited to this one. Specifically, the transmission point 102 may perform scheduling processing and the like for the terminal 104, notify the transmission point 101 of the result of the scheduling processing, and perform cooperative communication.

Referring to FIG. 2, the transmission point 101 includes a higher layer 201, a shared channel generation unit 202, a terminal-specific reference signal multiplexing unit 203, a precoding unit 204, a control channel generation unit 205, a cell-specific reference signal multiplexing unit 206, a transmit signal generation unit 207, a transmission unit 208, a transmit antenna 209, a receive antenna 210, a reception unit 211, and a feedback information processing unit 212.

The receive antenna 210 receives a data signal including feedback information transmitted from the terminal 104 via the uplink (for example, PUCCH (Physical Uplink Control Channel), PUSCH (Physical Uplink Shared Channel), or the like) 107.

The reception unit 211 performs channel equalization processing, demodulation processing, decoding processing, and so forth on the signal received by the receive antenna 210, identifies the feedback information from the received signal, and outputs the identified feedback information to the feedback information processing unit 212.

In the case where there are a plurality of terminals 104 that perform communication with the transmission point 101, the transmission point 101 may employ various multiple access schemes, such as SC-FDMA (Single carrier-frequency division multiple access), Clustered DFT-S-OFDM (Discrete Fourier Transform-Spread-OFDM), OFDMA, time division multiple access, and code division multiple access for the uplink 107 to multiplex data signals addressed to the terminals 104. Also, as a method for allowing the transmission point 101 to identify feedback information of each terminal 104, various methods may be used. For example, the transmission point 101 specifies a resource (element used to transmit a signal and obtained by division based on time, frequency, code, spatial regions, or the like) on which the corresponding terminal 104 transmits its feedback information, and the terminal 104 transmits the feedback information on the specified resource. In this way, the transmission point 101 is able to identify the feedback information of each terminal 104. This may also be realized by adding identification information unique to each terminal 104 to the corresponding feedback information.

The feedback information processing unit 212 generates, based on the feedback information input thereto, adaptive control information used to perform adaptive control of a data signal to be transmitted to the terminal 104. The generated adaptive control information can be shared in the entire transmission point 101 and can be used in various kinds of processing. For example, the adaptive control information is output to the shared channel generation unit 202 in which adaptive control processing is performed on a data signal addressed to the terminal 104. Also, the generated adaptive control information can be shared in the entire transmission point 102 similarly, and can be used in various kinds of processing, such as cooperative communication.

The higher layer 201 generates a data signal (transport block, codeword, or information data) addressed to the terminal 104, and outputs the generated data signal to the shared channel generation unit 202. Here, the data signal can be set as units in which error correction coding processing is performed. Alternatively, the data signal can be set as units in which retransmission control, such as HARQ (Hybrid Automatic Repeat reQest), is performed. The transmission point 101 is capable of simultaneously transmitting a plurality of pieces of information data to the terminal 104.

The shared channel generation unit (data channel generation unit or shared channel mapping unit) 202 performs, based on the adaptive control information output by the feedback information processing unit, adaptive control processing on the data signal output by the higher layer 201, and generates a shared channel (PDSCH; Physical Downlink Shared Channel or data channel) addressed to the terminal 104. Specifically, during adaptive control, the shared channel generation unit 202 performs coding processing for performing error correction coding, scrambling processing for adding scramble code unique to the terminal 104, modulation processing for using a multi-level modulation scheme or the like, layer mapping processing for performing spatial multiplexing such as MIMO, and so forth. Here, during the layer mapping processing, the shared channel generation unit 202 maps, based on the rank set for the terminal 104, one or more layers (streams). The shared channel is mapped to a shared channel region for the transmission point 101, and is then transmitted. In the case where the transmission point 101 and the transmission point 102 perform cooperative communication, the shared channel is mapped to a shared channel region for the transmission point 101 and a shared channel region for the transmission point 102, and is then transmitted.

The terminal-specific reference signal multiplexing unit (terminal-specific reference signal generation unit) 203 generates a terminal-specific reference signal (data channel demodulation reference signal, shared channel demodulation reference signal, terminal-specific control channel demodulation reference signal, DM-RS (Demodulation Reference Signal), DRS (Dedicated Reference Signal), Precoded RS, or UE-specific RS) specific to the terminal 104, and multiplexes the terminal-specific reference signal onto the shared channel. Here, the terminal-specific reference signal is configured based on the rank of the shared channels to be multiplexed, and is multiplexed onto individual layers. Note that it is preferable that the terminal-specific reference signals in the individual layers be orthogonal and/or quasi-orthogonal to one another. The terminal-specific reference signal multiplexing unit 203 may generate the terminal-specific reference signal, and the generated terminal-specific reference signal may be multiplexed by the transmit signal generation unit 207 described later.

The precoding unit 204 performs precoding processing specific to the terminal 104, on the shared channel and the terminal-specific reference signal output by the terminal-specific reference signal multiplexing unit 203. Here, the precoding processing is preferably performed in such a manner that a precoding matrix (precoding weight) is applied to the shared channel and the terminal-specific reference signal so as to enable efficient reception at the terminal 104 (for example, so as to maximize receive power, reduce interference from nearby cells, or reduce interference to nearby cells), and phase rotation, amplitude control, power control, and so forth are performed. In the precoding processing, CDD (Cyclic Delay Diversity) or transmit diversity (such as SFBC (Spatial Frequency Block Code), STBC (Spatial Time Block Code), TSTD (Time Switched Transmission Diversity), or FSTD (Frequency Switched Transmission Diversity)), but not limited to, can be used.

The terminal-specific reference signal is a signal known to both the transmission point 101 and the terminal 104. Further, precoding processing specific to the terminal 104 is performed by the precoding unit 204 on the shared channel and the terminal-specific reference signal. Accordingly, the terminal-specific reference signal allows the terminal 104 to estimate, when demodulating the shared channel, a downlink channel state between the transmission point 101 and the terminal 104 and an equalization channel of the preceding weight applied by the precoding unit 204. That is, the terminal 104 is able to demodulate the preceded signal without requiring the transmission point 101 to notify the terminal 104 of the preceding weight applied by the precoding unit 204.

When transmitting control information to the terminal 104, the control channel generation unit (control channel region allocation unit, control channel mapping unit, or cell-specific control channel generation unit) 205 performs predetermined error correction coding processing, and generates a control channel (PDCCH; Physical Downlink Control Channel) addressed to the terminal 104. The control channel is mapped to a control channel region for the transmission point 101, and is then transmitted. In the case where the transmission point 101 and the transmission point 102 perform cooperative communication, the control channel is mapped to a control channel region for the transmission point 101 and a control channel region for the transmission point 102, and is then transmitted.

The format of control information is predefined. For example, control information can be defined in accordance with the purpose of notification made to the terminal 104 by the transmission point 101. Specifically, the control information may be defined as allocation information of a downlink data channel allocated to the terminal 104, allocation information of an uplink data channel (PUSCH; Physical Uplink Shared Channel) and/or an uplink control channel (PUCCH; Physical Uplink Control Channel) allocated to the terminal 104, information for controlling transmit power for the terminal 104, and so forth. Accordingly, for example, when transmitting a downlink data signal to the terminal 104, the transmission point 101 transmits a control channel on which control information including allocation information of a downlink data channel allocated to the terminal 104 is mapped and a data channel on which a data signal allocated based on the control information is mapped. Alternatively, for example, when allocating an uplink data channel to the terminal 104, the transmission point 101 transmits a control channel on which control information including allocation information of an uplink data channel allocated to the terminal 104 is mapped. Alternatively, the transmission point 101 may transmit a plurality of different or identical pieces of control information in different or identical formats to the same terminal 104 on the same subframe. Alternatively, when transmitting a downlink data signal to the terminal 104, the transmission point 101 may transmit a downlink data channel using a subframe different from a subframe used to transmit a control channel on which control information including allocation information of a downlink data channel allocated to the terminal 104 is mapped.

The control channel generated by the control channel generation unit 205 is transmitted using a control channel region specific to the transmission point 101, and thus is also referred to as a “cell-specific control channel”. Alternatively, the control channel can be transmitted using a region different from the control channel region. For example, the control channel can be transmitted using a shared channel region. A region on a shared channel to which a control channel can be mapped is configured as a region specific to the terminal 104. The control channel transmitted using a region that can be configured to be specific to the terminal 104 is also referred to as a “terminal-specific control channel”. Similarly to the shared channel, the terminal-specific control channel can be subjected to terminal-specific reference signal multiplexing processing performed by the terminal-specific reference signal multiplexing unit 203 and precoding processing performed by the precoding unit 204. The region on the shared channel to which the control channel can be mapped is a region that is specific to the terminal 104 and is configured via RRC signaling by the transmission point 101, and thus is also referred to as a “terminal-specific control channel region”. The terminal-specific control channel region is configured using, as units, a region in which two resource blocks each constituted by a predetermined frequency-direction region and a predetermined time-direction region are continuously arranged in the time direction.

The cell-specific reference signal multiplexing unit (cell-specific reference signal generation unit or channel state information reference signal generation unit) 206 generates a cell-specific reference signal (channel state information reference signal, CRS (Common RS), Cell-specific RS, Non-precoded RS, or cell-specific control channel demodulation reference signal) that is known to both the transmission point 101 and the terminal 104 in order to measure a downlink channel state between the transmission point 101 and the terminal 104. The generated cell-specific reference signal is multiplexed onto the signal output by the control channel generation unit 205. The channel state information reference signal is transmitted from each of transmit antenna ports of a plurality of transmission points arranged at geographically different locations. Alternatively, the cell-specific reference signal multiplexing unit 206 may generate a cell-specific reference signal, and the generated cell-specific reference signal may be multiplexed by the transmit signal generation unit 207 described later.

As the cell-specific reference signal, any given signal (sequence) known to both the transmission point 101 and the terminal 104 may be used. For example, a random number or a pseudo-noise sequence based on a pre-assigned parameter, such as a number (cell ID) specific to the transmission point 101, may be used. As the method for performing orthogonalization between antenna ports, a method such as a method for setting resource elements onto which the cell-specific reference signal is to be mapped to null (zero) between antenna ports, a method of performing code division multiplexing using a pseudo-noise sequence, or a combination thereof may be used. Note that the cell-specific reference signal is not necessarily required to be multiplexed in all subframes, and may be multiplexed in only some subframes.

The cell-specific reference signal is a reference signal that is multiplexed after being precoded by the preceding unit 204. Accordingly, the terminal 104 is able to measure a downlink channel state between the transmission point 101 and the terminal 104 by using the cell-specific reference signal. As a result, the terminal 104 is able to demodulate a signal that has not been precoded by the precoding unit 204. For example, a control channel can be demodulated based on the cell-specific reference signal.

The transmit signal generation unit (channel mapping unit) 207 performs mapping processing in which the signal output by the cell-specific reference signal multiplexing unit 206 is mapped onto resource elements for respective antenna ports. Specifically, the transmit signal generation unit 207 maps a shared channel to the shared channel region. The transmit signal generation unit 207 maps a control channel to the control channel region. In the case where a control channel is transmitted using a terminal-specific control channel region, the transmit signal generation unit 207 maps the control channel to the terminal-specific control channel region on the shared channel. Herein, the transmission point 101 is capable of mapping control channels addressed to a plurality of terminals to a cell-specific control channel region and/or terminal-specific control channel regions.

The cell-specific control channel and the terminal-specific control channel may be control channels to be transmitted using different resources, and/or control channels to be demodulated using different reference signals, and/or control channels that can be transmitted in accordance with different RRC states at the terminal 104. To each control channel, control information of any format can be mapped. The format of control information that can be mapped to each control channel can be defined.

The transmission unit 208 performs IFFT (Inverse Fast Fourier Transform), addition of guard intervals, conversion processing to radio frequency, and so forth. The transmit antenna 209, the number of which (number of transmit antenna ports) is one or multiple, transmits the transmit signal output by the transmission unit 208.

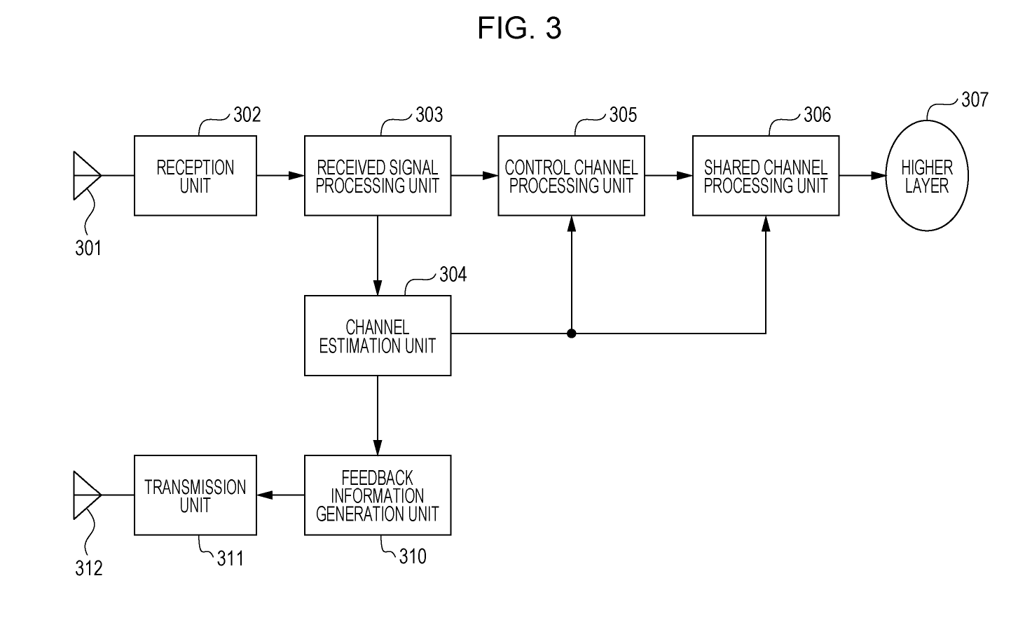

FIG. 3 is a schematic block diagram illustrating the configuration of the terminal 104 according to this embodiment. Referring to FIG. 3, the terminal 104 includes a receive antenna 301, a reception unit 302, a received signal processing unit 303, a channel estimation unit 304, a control channel processing unit 305, a shared channel processing unit 306, a higher layer 307, a feedback information generation unit 310, a transmission unit 311, and a transmit antenna 312.

The receive antenna 301, the number of which (the number of receive antenna ports) is one or multiple, receives a signal transmitted by the transmission point 101. The reception unit 302 performs, on the signal received by the receive antenna 301, conversion processing from radio frequency into a baseband signal, removal of added guard intervals, and time-frequency conversion processing such as FFT (Fast Fourier Transform).

The received signal processing unit 303 demaps (separates) the signals that have been mapped by the transmission point 101. Specifically, the received signal processing unit 303 demaps the control channel and/or the shared channel, and outputs the obtained channels to the control channel processing unit 305. Also, the received signal processing unit 303 demaps the multiplexed cell-specific reference signal, and/or the terminal-specific reference signal, and/or the channel state information reference signal, and outputs the obtained reference signals to the channel estimation unit 304.

The channel estimation unit 304 performs, based on the cell-specific reference signal and/or the terminal-specific reference signal, channel estimation for resources of the control channel and/or the shared channel. The channel estimation unit 304 outputs the estimated result of channel estimation to the control channel processing unit 305 and the shared channel processing unit 306. Specifically, based on the terminal-specific reference signal that has been multiplexed on the shared channel, the channel estimation unit 304 estimates (performs channel estimation of), for each receive antenna port of each layer (rank or spatial multiplexing), alterations (frequency response or transfer function) in amplitude and phase of each resource element so as to determine a channel estimate value. Also, based on the cell-specific reference signal that has been multiplexed on the control channel, the channel estimation unit 304 estimates, for each receive antenna port corresponding to the corresponding transmit antenna port, alterations in amplitude and phase of each resource element so as to determine a channel estimate value. Note that in the case where the control channel is possibly mapped to the terminal-specific control channel region on the shared channel region, the estimated result of channel estimation obtained based on the terminal-specific reference signal mapped to the terminal-specific control channel region is output to the control channel processing unit 305. Also, based on the channel state information reference signal, the channel estimation unit 304 performs channel estimation for generating feedback information, and outputs the estimation result to the feedback information generation unit 310. That is, the feedback information generation unit 310 estimates, based on the channel state information reference signal transmitted from the transmit antenna ports (CSI ports), channel states between the base station (transmission point 101 and/or 102) and the terminal 104.

The control channel processing unit 305 searches for a control channel addressed to the terminal 104. Specifically, the control channel processing unit 305 sequentially searches for, by performing demodulation and decoding processing, all or some control channel candidates which are obtained based on the type of control information, a position of a resource to which the control channel is mapped, the size of the resource to which the control channel is mapped, and so forth. As a method for determining whether or not control information of interest is control information addressed to the terminal 104, the control channel processing unit 305 uses error detection code (for example, CRC (Cyclic Redundancy Check) code) added to the control information. Such a search method is also referred to as “blind decoding”.

When detecting a control channel addressed to the terminal 104, the control channel processing unit 305 identifies control information mapped to the detected control channel. The identified control information is shared in the entire terminal 104 (including the higher layer) and is used in various kinds of control performed in the terminal 104, such as downlink data channel reception processing, uplink data channel and control channel transmission processing, and uplink transmit power control.

In the case where control information including downlink data channel allocation information has been mapped to the detected control channel, the control channel processing unit 305 outputs the shared channel demapped by the received signal processing unit 303 to the shared channel processing unit 306.

The control channel processing unit 305 is capable of performing search processing for searching for a control channel mapped to the terminal-specific control channel region. The configuration of the terminal-specific control channel region is made using higher-layer control information (for example, RRC (Radio Resource Control) signaling) which the transmission point 101 notifies the terminal 104 of. For example, the configuration of the terminal-specific control channel region is made using terminal-specific configuration information regarding the terminal-specific control channel. The terminal-specific configuration information regarding the terminal-specific control channel is control information used to configure the terminal-specific control channel and is configuration information specific to the terminal 104.

For example, in the case where notification of the terminal-specific configuration information regarding the terminal-specific control channel is made and the terminal-specific control channel region is configured by the transmission point 101, the control channel processing unit 305 searches for a control channel addressed to the terminal 104 and mapped to the terminal-specific control channel region. In this case, the control channel processing unit 305 may further search part of the cell-specific control channel region. For example, the control channel processing unit 305 may search a cell-specific search region in the cell-specific control channel region. In the case where notification of the terminal-specific configuration information of the terminal-specific control channel is not made by the terminal 101 and the terminal-specific control channel region is not configured, the control channel processing unit 305 searches for a control channel addressed to the terminal 104 and mapped to the cell-specific control channel region.

Here, when searching for a control channel addressed to the terminal 104 and mapped to the terminal-specific control channel region, the control channel processing unit 305 uses the terminal-specific reference signal to demodulate possible control channels. Also, when searching for a control channel addressed to the terminal 104 and mapped to the cell-specific control channel region, the control channel processing unit 305 uses the cell-specific reference signal to demodulate possible control channels.

The shared channel processing unit 306 performs, on the shared channel input from the control channel processing unit 305, channel compensation processing (filter processing) using the channel estimation result input from the channel estimation unit 304, layer demapping processing, demodulation processing, descrambling processing, error correction decoding processing, and so forth, and outputs the result to the higher layer 307. Note that channel estimation is performed for resource elements to which the terminal-specific reference signal has not been mapped, by performing interpolation, averaging, or the like in the frequency direction and the time direction based on resource elements to which the terminal-specific reference signal has been mapped. In the channel compensation processing, channel compensation is performed on the input shared channel using the estimated channel estimate value so as to detect (restore) signals of individual layers based on the data signal. As the detection method, equalization based on ZF (Zero Forcing) rule or MMSE (Minimum Mean Square Error) rule, turbo equalization, interference removal, or the like may be used. In the layer demapping processing, demapping processing is performed to demap signals of individual layers into individual data signals. The following processing is performed for each data signal. In the demodulation processing, demodulation is performed based on the modulation scheme used. In the descrambling processing, descrambling is performed based on scramble code used. In the decoding processing, error correction decoding is performed based on a coding scheme applied.

The feedback information generation unit 310 generates, based on the channel estimation result obtained by the channel estimation unit 304 using the channel state information reference signal, feedback information for used in adaptive control. As the feedback information, recommended transmission format information (implicit information) for the transmission point 101 and/or the transmission point 102; or channel state information (explicit information) between the transmission point 101 and/or the transmission point 102 and the terminal 104 is generated. Also, as units in which the feedback information is generated, the frequency direction (for example, in units of subcarriers, resource elements, resource blocks, or sub-bands constituted by a plurality of resource blocks), the time direction (for example, in units of OFDM symbols, subframes, slots, or wireless frames), the spatial direction (for example, in units of antenna ports, transmit antennas, or receive antennas), or the like may be used, and further a combination thereof may be used.

In the case where the recommended transmission format information for the transmission point 101 and/or the transmission point 102 is generated as the feedback information, the feedback information generation unit 310 generates, based on the channel estimation result, a difference between powers for transmission points or transmit antenna ports or power difference information which is information representing a difference between powers for transmit antenna ports; rank information (RI; Rank Indicator) which is information representing the maximum number of layers that can be spatially multiplexed; precoding matrix information (PMI; Precoding Matrix Indicator) which is information representing a precoding matrix preferably used in precoding processing; and channel quality information (CQI; Channel Quality Indicator) which is information representing a modulation scheme and a coding rate that satisfy predetermined transmission quality. Details will be described later.

In the case where channel state information between the transmission point 101 and/or the transmission point 102 and the terminal 104 is generated as the feedback information, the feedback information generation unit 310 generates, based on the channel estimation result, channel state information including information representing a difference between receive powers from transmission points or transmit antenna ports. In the case where the generated channel state information does not include the information representing a difference between receive powers from the transmission points or transmit antenna ports, the feedback information generation unit 310 generates, separately from the channel state information, the information representing a difference between receive powers from the transmission points or transmit antenna ports.

The generated feedback information is input to the transmission unit 311. In order to transmit (feed back) the feedback information output by the feedback information generation unit 310 to the transmission point 101 and/or the transmission point 102, the transmission unit 311 performs coding processing, modulation processing, OFDM signal generation processing, guard interval insertion processing, frequency conversion processing, and so forth to generate uplink control information. Further, the transmit antenna 312 transmits the generated uplink control information to the transmission point 101 and/or the transmission point 102 via an uplink channel (PUCCH or PUCCH).

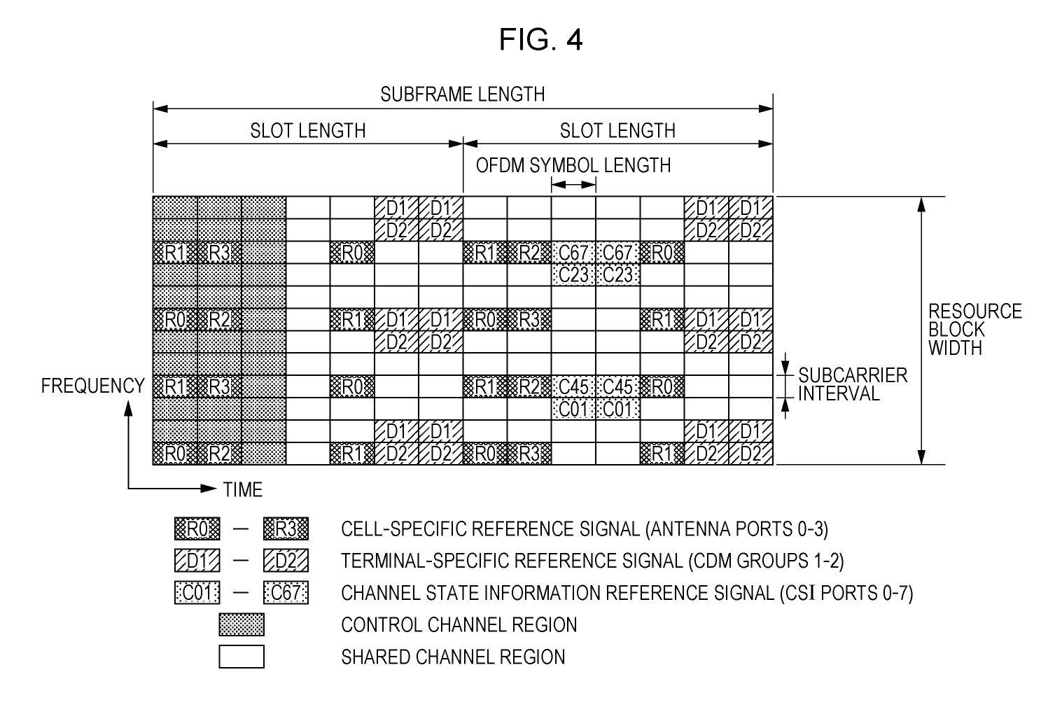

FIG. 4 is a diagram illustrating an example of a resource block pair to which signals are mapped by the transmission point 101 and/or the transmission point 102. One resource block (RB) is constituted by a predetermined frequency-direction region and a predetermined time-direction region. In one resource block pair, two resource blocks are continuously arranged in the time direction. FIG. 4 illustrates two resource blocks. One resource block is constituted by twelve subcarriers in the frequency direction and seven OFDM symbols in the time direction. A resource constituted by one OFDM symbol and one subcarrier is referred to as a “resource element”. Resource block pairs are arranged in the frequency direction, and the number of resource block pairs can be set for each base station. For example, the number of resource block pairs can be set to 6 to 110. A width in the frequency direction at this time is referred to as a “system bandwidth”. The time direction of a resource block pair is referred to as a “subframe”. Preceeding seven OFDM symbols and following seven OFDM symbols in the time direction in each subframe are each referred to as a “slot”. Also, in the following description, a resource block pair is also referred to simply as a “resource block”.

Among resource elements illustrated in FIG. 4, resource elements R0 to R3 represent cell-specific reference signals for antenna ports 0 to 3, respectively. The cell-specific reference signals illustrated in FIG. 4 are for the case of four antenna ports; however, the number of antenna ports can be changed. For example, cell-specific reference signals for one antenna port or two antenna ports can be mapped.

Among the resource elements illustrated in FIG. 4, resource elements D1 to D2 represent terminal-specific reference signals of CDM (Code Division Multiplexing) group 1 to CDM group 2, respectively. The terminal-specific reference signals of CDM group 1 and CDM group 2 are each subjected to code division multiplexing using orthogonal code, such as Walsh code, within the CDM group. Also, the terminal-specific reference signals of CDM group 1 and CDM group 2 are mutually subjected to FDM (Frequency Division Multiplexing) across the CDM groups. Here, the terminal-specific reference signals can be configured for up to eight layers using eight antenna ports (antenna ports 7 to 14) in accordance with the number of spatially multiplexed shared channels mapped to the resource block pair. Also, the spreading code length for CDM or the number of or positions of resource elements to which the terminal-specific reference signals are mapped can be changed in accordance with the configured number of layers.

For example, the terminal-specific reference signals for the case of 1 to 2 layers are formed of spreading codes of 2-chip length as antenna ports 7 to 8, and are mapped to CDM group 1. The terminal-specific reference signals for the case of 3 to 4 layers are formed of spreading codes of 2-chip length as antenna ports 7 to 10, and are mapped to CDM group 1 (antenna ports 7 to 8) and CDM group 2 (antenna ports 9 to 10). The terminal-specific reference signals for the case of 5 to 8 layers are formed of spreading codes of 4-chip length as antenna ports 7 to 14, and are mapped to CDM group 1 and CDM group 2.

In the terminal-specific reference signals, scramble code is further applied to orthogonal code on each antenna port. This scramble code is generated based on control information notified by the control signaling point. For example, the scramble code is generated from a pseudo-noise sequence which is generated based on the cell ID and scramble ID notified by the control signaling point. For example, the scramble ID is a value of 0 or 1. Alternatively, the scramble ID and antenna port to be used may be jointly coded, and information representing the scramble ID and antenna port may be indexed.

Among the resource elements illustrated in FIG. 4, resource elements C01 to C67 represent channel state information reference signals for CSI port 0 to CSI port 7 (antenna port 15 to antenna port 22). That is, two resource elements C01 continuously arranged in the time direction represent channel state information reference signals for CSI port 0 and CSI port 1. Each of these channel state information reference signal is subjected to CDM using 2-chip orthogonal code. Also, two resource elements C23 that are continuously arranged in the time direction represent channel state information reference signals for CSI port 2 and CSI port 3. Each of these channel state information reference signals is subjected to CDM using 2-chip orthogonal code. Also, two resource elements C45 that are continuously arranged in the time direction represent channel state information reference signals for CSI port 4 and CSI port 5. Each of these channel state information reference signals is subjected to CDM using 2-chip orthogonal code. Also, two resource elements C67 that are continuously arranged in the time direction represent channel state information reference signals for CSI port 6 and CSI port 7. Each of these channel state information reference signals is subjected to CDM using 2-chip orthogonal code. As the orthogonal code used for CDM, Walsh code or the like can be used. Also, the channel state information reference signals can be transmitted from individual transmit antenna ports of multiple transmission points arranged at geographically different locations.

Now, a method for configuring a channel state information reference signal for the terminal 104 will be described. A plurality of resource element patterns (mapping positions) to which a channel state information reference signal is to be mapped within a resource block pair are defined in advance, and the channel state information reference signal is configured based on information representing the pattern. Specifically, control signaling point notifies the terminal 104 of channel-state-information-reference-signal configuration information via RRC signaling. The channel-state-information-reference-signal configuration information includes information representing the number of transmit antenna ports (number of CSI ports), information representing a resource element pattern to which a channel state information reference signal is mapped within a resource block pair, information representing a subframe to which the channel state information reference signal is mapped. Also, a plurality of channel state information reference signals can be configured for the terminal 104. Also, a channel state information reference signal of transmit power of zero (that is, muted resource element) can be configured for the terminal 104.

FIG. 4 illustrates a case where one piece of configuration information regarding channel state information reference signals for eight antenna ports is configured for the terminal 104. Now, a description will be given of a case where channel state information reference signals for CSI ports 0 to 3 and CSI ports 4 to 7 are respectively transmitted from the transmission point 101 and the transmission point 102 as illustrated in FIG. 1. The transmission point 101 maps channel state information reference signals for CSI ports 0 to 3 to the resource elements C01 and C23 illustrated in FIG. 4. The transmission point 101 does not map any signal to the resource elements C45 and C67 illustrated in FIG. 4. The transmission point 102 maps channel state information reference signals for CSI ports 4 to 7 to the resource elements C45 and C67 illustrated in FIG. 4. The transmission point 102 does not map any signal to resource elements C01 and C23 illustrated in FIG. 4.

In the case where a plurality of pieces of configuration information regarding channel state information reference signals are configured for the terminal 104, the channel state information reference signals can be mapped in the similar manner. For example, a description will be given of a case where two pieces of configuration information regarding channel state information reference signals for four antenna ports are configured for the terminal 104. It is preferable that channel state information reference signals to be configured be mapped to resource elements different from one another. For example, the transmission point 101 maps channel state information reference signals for CSI ports 0 to 3 to the resource elements C01 and C23 illustrated in FIG. 4, and does not map any signal to the resource elements C45 and C67 illustrated in FIG. 4. The transmission point 102 maps channel state information reference signals for CSI ports 0 to 3 to the resource elements C45 and C67 illustrated in FIG. 4, and does not map any signal to the resource elements C01 and C23 illustrated in FIG. 4.

Resource elements to which the individual reference signals are not mapped within a region constituted by preceding first to third OFDM symbols are configured as a region to which a control channel is to be arranged (control channel region). The region to which a control channel is to be arranged is mapped to preceding OFDM symbols of a subframe, and a predetermined number of OFDM symbols can be configured for each subframe. The predetermined number of OFDM symbols to which a control channel is to be arranged is broadcast (reported) as cell-specific control information via PCFICH (Physical Control Format Indicator Channel).

White resource elements represent a region to which a shared channel is to be arranged (shared channel region). The region to which a shared channel is to be arranged is mapped to following OFDM symbols within a subframe, that is, OFDM symbols different from the OFDM symbols to which a control channel is to be arranged within the subframe. For the region to which a shared channel is allocated, a predetermined number of OFDM symbols may be configured for each subframe. The whole or part of the region to which a shared channel is to be arranged may be mapped to predetermined fixed OFDM symbols regardless of the control channel region within the subframe. For example, a region to which a terminal-specific control channel is to be arranged (terminal-specific control channel region) may be mapped to fourth to fourteenth OFDM symbols within each subframe regardless of the control channel region within the subframe. The region to which a shared channel is to be arranged can be configured for each resource block pair.

The number of resource blocks can be changed in accordance with a frequency bandwidth (system bandwidth) used by a communication system. A communication system can use, for example, 6 to 110 resource blocks. Units of the system bandwidth are also referred to as “component carriers”. Further, a base station may configure a plurality of component carries for a terminal using frequency aggregation. For example, a base station can configure each component carrier to have a bandwidth of 20 MHz and configure five component carriers that are contiguous and/or non-contiguous in the frequency direction for a terminal. In this way, the total bandwidth that can be used by the communication system can be made equal to 100 MHz.

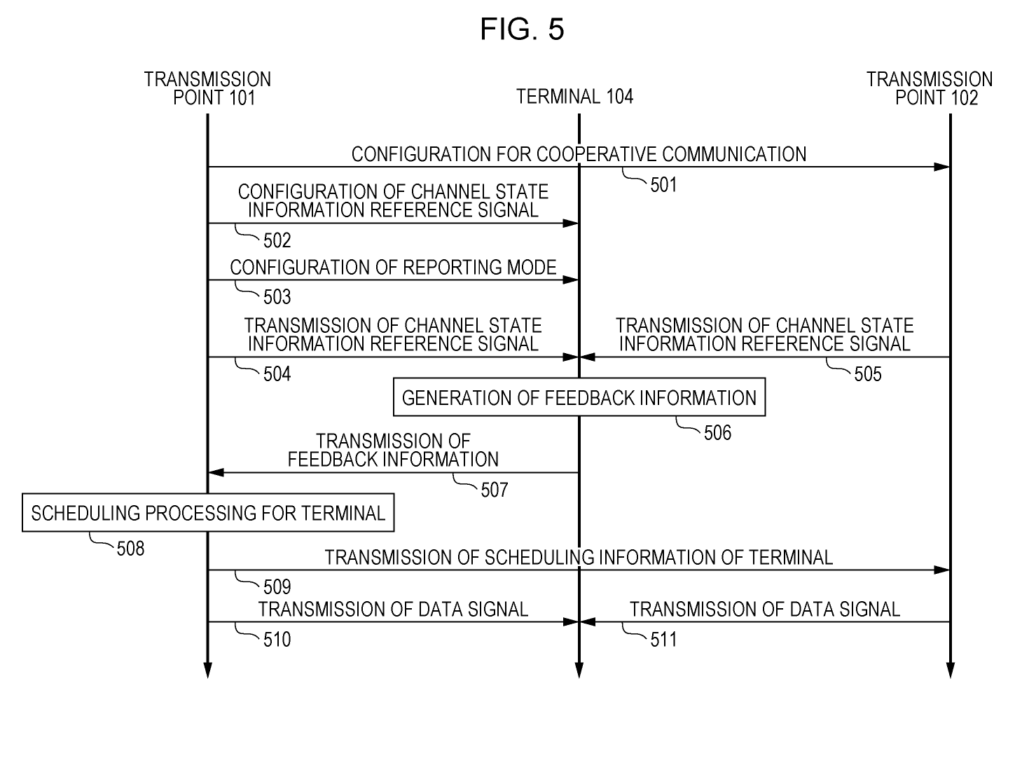

FIG. 5 is a diagram illustrating a flow diagram of the transmission point 101, the transmission point 102, and the terminal 104. In an example illustrated in FIG. 5, the transmission point 101 is a control signaling point and is a transmission point that receives feedback information from the terminal 104. In step 501, the transmission point 101 configures the transmission point 102 for cooperative communication with the terminal 104. The configuration for cooperative communication includes configuration necessary for performing cooperative communication with the terminal 104. For example, the configuration for cooperative communication includes configuration of channel state information reference signals used by the terminal 104 to perform cooperative communication.

In step 502, the transmission point 101 configures channel state information reference signals for the terminal 104. Specifically, the transmission point 101 notifies the terminal 104 of one or a plurality of pieces of channel-state-information-reference-signal configuration information so as to configure one or a plurality of sets of channel state information reference signals. Here, a set of channel state information reference signals are made up of channel state information reference signals for one, two, four, or eight antenna ports, which are represented by each of the pieces of channel-state-information-reference-signal configuration information. That is, one piece of channel-state-information-reference-signal configuration information specifies one, two, four, or eight CSI ports. Note that one piece of channel-state-information-reference-signal configuration information may configure a plurality of sets of channel state information reference signals.

In step 503, the transmission point 101 configures a reporting mode in the terminal 104. The reporting mode is information (mode) representing a predefined feedback method (reporting method) used by the terminal 104 to transmit feedback information to the transmission point 101.

In steps 504 and 505, the transmission point 101 and the transmission point 102 transmit the channel state information reference signals based on the configurations made in steps 501 and 502, respectively, and the terminal 104 receives these channel state information reference signals. In step 506, the terminal 104 generates, based on the received channel state information reference signals, feedback information. How the terminal 104 generates feedback information will be described later. In step 507, the terminal 104 transmits, based on the reporting mode configured in step 503, the generated feedback information to the transmission point 101.

In step 508, the transmission point 101 performs, based on the feedback information received from the terminal 104, scheduling processing for the terminal 104, and generates scheduling information for the terminal 104. The scheduling processing for the terminal 104 includes resource allocation processing for a shared channel including a data signal, adaptive control processing for the data signal, interference control processing for interference caused by a terminal different from the terminal 104, and so forth. In step 509, the transmission point 101 transmits the scheduling information for the terminal 104 to the transmission point 102 in order to perform cooperative communication with the terminal 104. Also, in step 509, the transmission point 101 transmits a data signal addressed to the terminal 104 to the transmission point 102. In steps 510 and 511, the transmission point 101 and the transmission point 102 transmit, based on the scheduling information generated in step 508, shared channels including the data signal to the terminal 104.

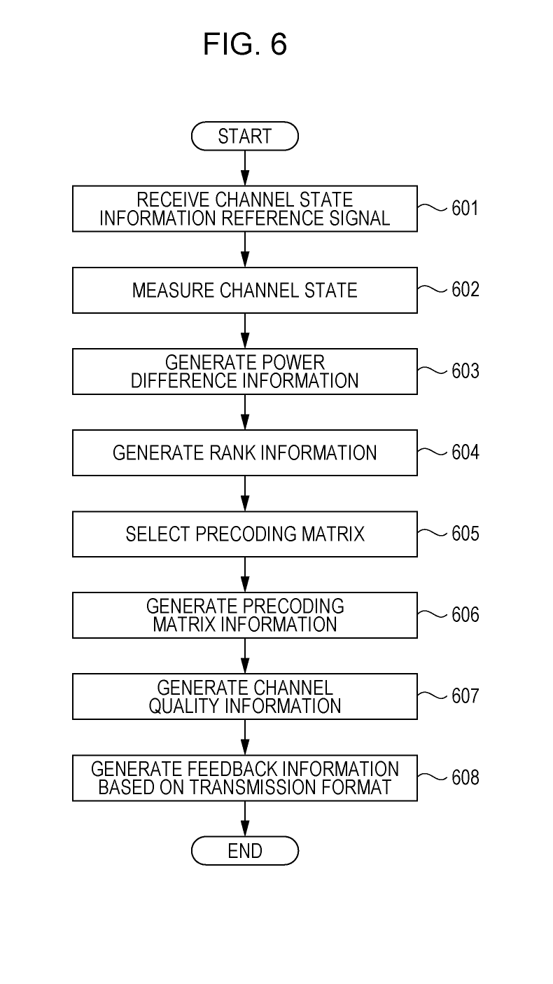

FIG. 6 is a diagram illustrating a flow diagram of how the terminal 104 generates feedback information. In step 601, the terminal 104 receives the channel state information reference signals, in accordance with the channel-state-information-reference-signal configuration information which the terminal 104 is notified of by the control signaling point. At this time, the terminal 104 is not necessarily required to know by which transmission point the received channel state information reference signals have been transmitted even in the case where the channel state information reference signals have been transmitted by the transmission point 101 and/or the transmission point 102. In step 602, the terminal 104 measures, using the received channel state information reference signals, channel states between the receive antenna and the corresponding transmit antenna ports (CSI ports) based on the channel state information reference signals.

In step 603, the terminal 104 measures, based on the channel states measured in step 602, a difference between powers for the transmission points or the transmit antenna ports, and generates power difference information which is information representing the difference between powers for the transmission points, transmit antenna ports, or groups of transmit antenna ports. That is, the terminal 104 measures a difference between powers for groups each made up of transmit antenna ports which are some of the transmit antenna ports, and generates power difference information representing the power difference. At this time, the terminal 104 receives in advance a notification or definition of control information necessary for measuring the power difference. Details about the method for measuring the power difference will be described later.

In step 604, the terminal 104 estimates, based on the channel states measured in step 602, the number of layers (rank) preferable for MIMO communication, and generates rank information (RI; Rank Indicator) which is information representing the preferable number of layers. Note that, when estimating the preferable number of layers, the terminal 104 can use the difference between powers for the transmission points or transmit antenna ports measured in step 603.

In step 605, the terminal 104 selects a preferable precoding matrix from among a plurality of predefined precoding matrices. The precoding matrix can be selected for various purposes; however, it is preferable that the selection be made to make the transmission quality of the terminal 104 preferable. Also, selection of the precoding matrix is made based on the number of layers estimated in step 604. Note that, when selecting the preferable precoding matrix, the terminal 104 can use the difference between powers for the transmission points or transmit antenna ports measured in step 603. In step 606, the terminal 104 generates precoding matrix information (PMI; Precoding Matrix Indicator) which is information representing the precoding matrix selected in step 605. The precoding matrix can be decided based on one or a plurality of pieces of precoding matrix information. For example, in the case where one precoding matrix is decided based on two pieces of precoding matrix information, first preceding matrix information (PMI1, i1) and second precoding matrix information (PMI2, i2) are defined.

In step 607, the terminal 104 selects a modulation scheme and a coding rate (MCS; Modulating and Coding Scheme) preferably used for a data signal, and generates channel quality information (CQI; Channel Quality Indicator) which is information representing the selected modulation scheme and coding rate. Here, the channel quality information is information representing an index of a predefined combination of the modulation scheme and the coding rate. Selection of the preferable modulation scheme and the preferable coding rate may be made based on a certain predefined criteria. For example, the terminal 104 selects the modulation scheme and the coding rate so that the data signal satisfies a predetermined quality. Specifically, the terminal 104 selects the modulation scheme and the coding rate with which an error rate of the data signal does not exceed 0.1 in the channel states measured in step 602. Note that when selecting the preferable modulation scheme and the preferable coding rate, the terminal 104 can use the difference between powers for the transmission points or transmit antenna ports measured in step 603.

In step 608, the terminal 104 generates feedback information according to the transmission format, from the power difference information generated in step 603, the rank information generated in step 604, the precoding matrix information generated in step 606, and the channel quality information generated in step 607. Here, the transmission format is configured based on the predefined format and the reporting mode which the terminal 104 is notified of by the control signaling point.

The following describes details about the method used by the terminal 104 to measure a difference between powers for transmission points, transmit antenna ports, or groups of transmit antenna ports.

Units in which (groups for which) the terminal 104 measures a difference between powers for transmission points, transmit antenna ports, and groups of transmit antenna ports can be predefined. Specifically, a group of transmit antenna ports is constituted by transmit antenna ports predefined from among a plurality of transmit antenna ports. The terminal 104 measures the power difference, based on the groups of transmit antenna ports predefined for power difference measurement. For example, in the case where one set of channel state information reference signals is configured by one piece of channel-state-information-reference-signal configuration information, the terminal 104 measures the power difference while treating one or a plurality of predefined transmit antenna ports as a group (unit). That is, the terminal 104 measures a difference between powers for groups each made up of transmit antenna ports which are some of the transmit antenna ports. Here, suppose that transmit antenna ports for the configured channel state information reference signals are divided into n groups. In this case, groups of transmit antenna ports are referred to as a “first group of transmit antenna ports” to an “n-th group of transmit antenna ports”. Specifically, as groups for power difference measurement, the first group of transmit antenna ports which are some of transmit antenna ports and the second group of transmit antenna ports which are some of the transmit antenna ports different from the first group of transmit antenna ports are predefined. The terminal 104 measures a power difference for the predefined groups. For example, for channel state information reference signals for eight antenna ports, the first group of transmit antenna ports which are CSI port 0 to CSI port 3 and the first group of transmit antenna ports which are CSI port 4 to CSI port 7 are predefined as groups for power difference measurement. Also, for example, in the case where a plurality of sets of channel state information reference signals are configured by a plurality of pieces of channel-state-information-reference-signal configuration information, the terminal 104 measures a difference between powers for groups while treating transmit antenna ports represented by the individual sets of channel state information reference signals as groups.

The terminal 104 can be notified of control information regarding groups (units) handled by the terminal 104 to measure a difference between powers for transmission points and transmit antenna ports, via RRC signaling or signaling on a control channel. That is, a group of antenna ports is constituted by transmit antenna ports which the terminal 104 is notified of by the control signaling point (base station) from among a plurality of transmit antenna ports. The terminal 104 measures a power difference, based on the notified control information regarding groups for power difference measurement. For example, the control signaling point notifies the terminal 104 of a correspondence relationship between groups for which the power difference is to be measured and channel state information reference signals configured for the terminal 104. Specifically, in the case where a plurality of sets of channel state information reference signals are configured for the terminal 104 by a plurality of pieces of channel-state-information-reference-signal configuration information, groups for which a power difference is to be measured include some or all of the configured sets of channel state information reference signals in the notified correspondence relationship. For example, the control signaling point notifies the terminal 104 of groups (sets) of transmit antenna ports, each of the groups corresponding to the configured channel state information reference signals. The control signaling point notifies the terminal 104 of, as control information regarding groups for power difference measurement, the first group of transmit antenna ports which are some of the transmit antenna ports and the second group of transmit antenna ports which are some of the transmit antenna ports different from those of the first group of transmit antenna ports. The terminal 104 measures a power difference, based on the control information regarding groups for power difference measurement. For example, one channel state information reference signal for eight antenna ports is configured and antenna ports are divided into two groups, the terminal 104 is notified of, as groups for power difference measurement, the first group of transmit antenna ports which are CSI port 0 to CSI port 3 and the second group of transmit antenna ports which are CSI port 4 to CSI port 7. Alternatively, groups of transmit antenna ports for power difference measurement may be decided by the terminal 104 and information thereon may be generated as feedback information. For example, the terminal 104 may decide the groups based on the measured channel states.

As described above, the terminal 104 measures a difference between powers for transmission points, transmit antenna ports, or groups of transmit antenna ports, and makes a notification regarding the power difference. In this way, a plurality of transmission points arranged in geographically different locations can efficiently and effectively perform cooperative communication with the terminal 104. Specifically, because a base station (transmission point) is notified of a difference between receive powers from the transmission points which is caused by relative positions between the terminal 104 and the plurality of transmission points, the base station can dynamically perform cooperative communication while taking into consideration the difference in receive power. Also, because the terminal 104 selects a precoding matrix while taking into consideration the difference in receive power, the terminal 104 can highly accurately select a preferable precoding matrix. Also, because the terminal 104 selects a modulation scheme and a coding rate for a data signal while taking into consideration the difference in receive power, the terminal 104 can highly accurately select a preferable modulation scheme and a preferable coding rate.

Also, the terminal 104 is capable of switching between whether or not to measure a difference between powers for transmission points, transmit antenna ports, or groups of transmit antenna ports. For example, the terminal 104 is notified by the control signaling point of information indicating whether or not a power difference is to be measured. Alternatively, for example, the terminal 104 is capable of deciding whether or not to measure a power difference, based on control information which the terminal 104 is notified of by the control signaling point. Specifically, the terminal 104 is capable of deciding whether or not to measure the power difference, based on the transmission mode, the reporting mode, the number of transmit antenna ports, the channel state information reference signals to be configured, and so forth which the terminal 104 is notified of by the control signaling point. Alternatively, the terminal 104 is capable of deciding whether or not to measure the power difference, depending on whether a terminal-specific control channel region is configured by the control signaling point. For example, in the case where a terminal-specific control channel region is configured by the control signaling point, the terminal 104 measures the power difference, and generates the power difference information. Alternatively, the terminal 104 is notified of information indicating whether or not to measure the power difference by the control signaling point on a subframe-by-subframe basis. For example, one-bit flag serves as information indicating whether or not to measure the power difference on a subframe-by-subframe basis, and information represented by the one-bit flag is generated as bitmap-format information for a predetermined number of subframes.

Here, the transmission mode is configured by a transmission mode (transmissionMode) which the terminal 104 is notified of via RRC signaling. The transmission mode is information representing a transmission method used by the control signaling point to communicate with the terminal 104. For example, the transmission mode is predefined as transmission modes 1 to 10. The transmission mode 1 is a transmission mode that employs a single-antenna-port transmission scheme in which antenna port 0 is used. The transmission mode 2 is a transmission mode that employs a transmit diversity scheme. The transmission mode 3 is a transmission mode that employs a cyclic delay diversity scheme. The transmission mode 4 is a transmission mode that employs a closed-loop spatial multiplexing scheme. The transmission mode 5 is a transmission mode that employs a multi-user MIMO scheme. The transmission mode 6 is a transmission mode that employs a closed-loop spatial multiplexing scheme in which a single antenna port is used. The transmission mode 7 is a transmission mode that employs a single-antenna-port transmission scheme in which antenna port 5 is used. The transmission mode 8 is a transmission mode that employs a closed-loop spatial multiplexing scheme in which antenna ports 7 to 8 are used. The transmission mode 9 is a transmission mode that employs a closed-loop spatial multiplexing scheme in which antenna ports 7 to 14 are used. The transmission modes 1 to 9 are also referred to as a “first transmission mode”.

The transmission mode 10 is defined as a transmission mode different from the transmission modes 1 to 9. For example, the transmission mode 10 can be defined as a transmission mode that employs a CoMP scheme (cooperative communication scheme). Here, extension resulting from introduction of the CoMP scheme includes optimization of and improvement in accuracy of a channel state report (for example, introduction of precoding information and information on a phase difference for transmission points that are preferable for CoMP communication) and so forth. Alternatively, the transmission mode 10 can be a transmission mode that employs a communication scheme that is extension (enhancement) of the multi-user MIMO scheme which can be implemented using the communication schemes represented by the transmission modes 1 to 9. Here, extension of the multi-user MIMO scheme includes optimization of or improvement in accuracy of a channel state report (for example, introduction of CQI (Channel Quality Indicator) information preferable for multi-user MIMO communication or the like), improvement in orthogonality between terminals multiplexed within the same resource, and so forth.

Alternatively, the transmission mode 10 can be a transmission mode that employs, in addition to all or some of the communication schemes represented by the transmission modes 1 to 9, the CoMP scheme and/or the extended multi-user MIMO scheme. For example, the transmission mode 10 can be a transmission mode that employs, in addition to the communication scheme represented by the transmission mode 9, the CoMP scheme and/or the extended multi-user MIMO scheme. Alternatively, the transmission mode 10 can be a transmission mode in which a plurality of channel state information reference signals are configured. The transmission mode 10 is also referred to as a “second transmission mode”.

Here, the reporting mode is configured based on channel-state-report configuration information which the terminal 104 is notified of via RRC signaling. The channel-state-report configuration information includes aperiodic-channel-state-report configuration information (cqi-Report ModeAperiodic) and periodic-channel-state-report configuration information (CQI-ReportPeriodic). The aperiodic-channel-state-report configuration information is configuration information used to aperiodically report channel states in the downlink 105 and the downlink 106 via the uplink shared channel (PUSCH). The periodic-channel-state-report configuration information is configuration information used to periodically report channel states in the downlink 105 and the downlink 106 via the uplink control channel (PUCCH).

As described above, the terminal 104 switches between whether or not to measure a difference between powers for transmission points, transmit antenna ports, or groups of transmit antenna ports. In this way, the terminal 104 can configure preferable feedback information depending on whether or not cooperative communication is performed. For example, in the case where the terminal 104 does not perform cooperative communication, the terminal 104 does not notify the base station of, as the feedback information, the power difference information. In this way, the number of bits (overhead) of the feedback information can be reduced.

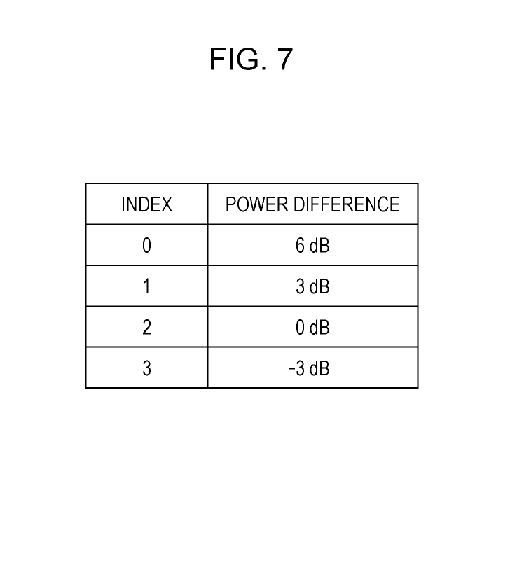

FIG. 7 is a diagram illustrating an example of the power difference information used as the feedback information. The power difference information illustrated in FIG. 7 represents four power differences, each of which is represented by two-bit information, and represents a power difference for two groups. That is, in the example illustrated in FIG. 7, a power difference for one group from another group is 6 dB, 3 dB, 0 dB, and −3 dB. The terminal 104 measures the power difference, and generates, as the power difference information, an index corresponding to the measured power difference. Note that, instead of the power difference information, amplitude difference information may be used as the feedback information. The amplitude difference information is information representing a difference between amplitudes for transmission points or transmit antenna ports.

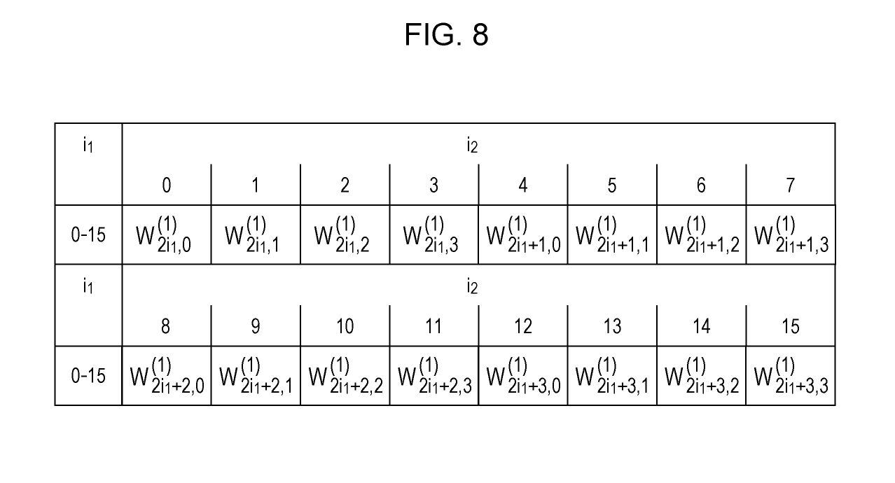

Now, an example of a method used by the terminal 104 to select a preceding matrix while taking into consideration the power difference measured by the terminal 104 will be described. FIG. 8 is a diagram illustrating an example of precoding matrix information for the number of layers of 1. FIG. 8 illustrates a precoding matrix for eight antenna ports, and illustrates a case where preceding four antenna ports (CSI port 0 to CSI port 3) and following four antenna ports (CSI port 4 to CSI port 7) are groups for power difference measurement. One precoding matrix is represented by two pieces of precoding matrix information i₁ and i₂. Also, a precoding matrix W⁽¹⁾_{m,n} is represented by Equation below.

$$\begin{matrix}[ Equation 1 ] & \\ {W}_{m , n}^{( 1 )} = \frac{1}{\sqrt{8}} [ \begin{matrix}{v}_{m} \\ α {ϕ}_{n} {v}_{m}\end{matrix} ] & ( 1 )\end{matrix}$$

Here, vₘ and φₙ are denoted by Equations below.

[Equation 2]

vₘ=[1 e^{j2πm/32} e^{j4πm/32} e^{j6πm/32}]^{T} (2)

[Equation 3]

φₙ=e^{jπn/2} (3)

That is, a precoding matrix represented by Equation 1 is a matrix with eight rows and one column. The column direction of the matrix of Equation (1) represents layers of MIMO multiplexing, whereas the row direction of the matrix of Equation (1) represents transmit antenna ports. Transmit antenna port numbers (CSI port 0 to CSI port 7) are sequentially assigned from the top in the row direction of the matrix of Equation (1). Also, i₁ and i₂ each represent any of 0 to 15. Accordingly, there are 256 kinds for the precoding matrix W⁽¹⁾_{m,n}. For example, in the case where and i₂ are 5 and 11, respectively, coefficients m and n in the precoding matrix are 12 and 3, respectively.

Also, a is a constant obtained from the power difference measured by the terminal 104. For example, a represents an offset value of an element (preceding weight) used in precoding processing and corresponding to the power difference measured by the terminal 104. That is, a is an offset value for the first group of transmit antenna ports which are CSI port 0 to CSI port 3 and the second group of transmit antenna ports which are CSI port 4 to CSI port 7, and represents an offset value corresponding to the power difference measured by the terminal 104. Note that the power difference measured by the terminal 104 may be contained in preceding matrices, and the terminal 104 may select a preferable precoding matrix from among preceding matrices containing the power difference, and make a notification of precoding matrix information corresponding to the selected precoding matrix.

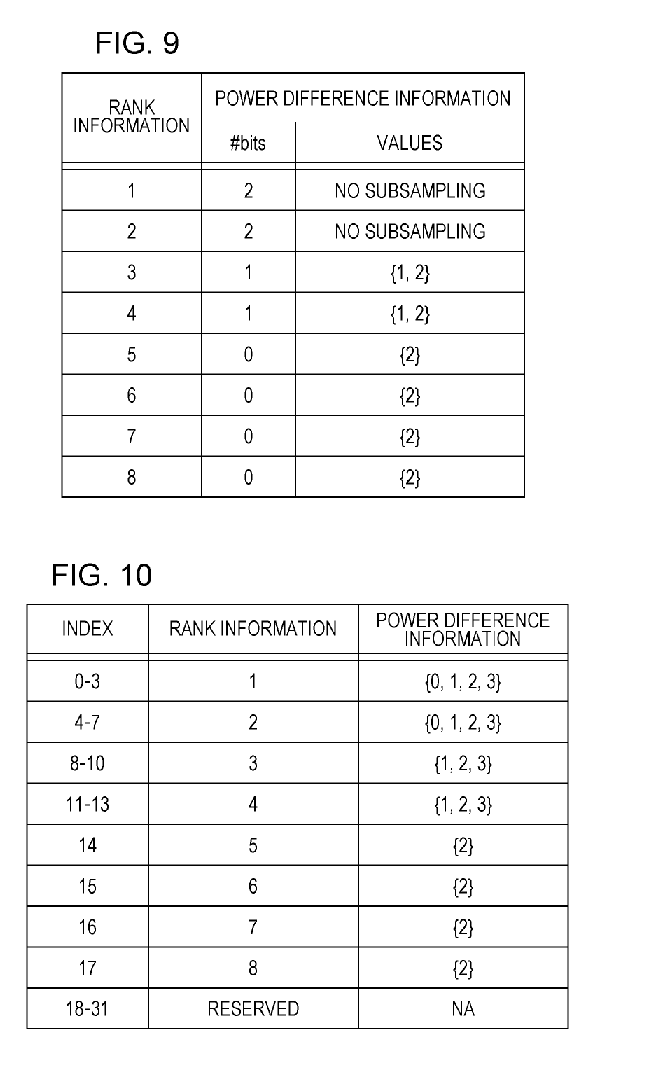

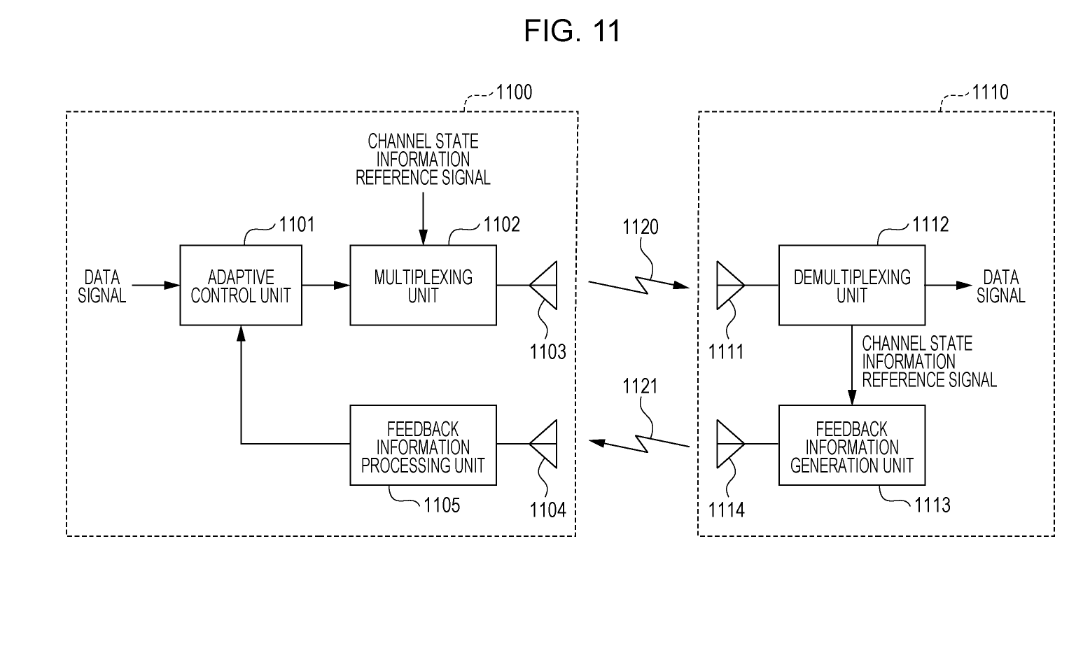

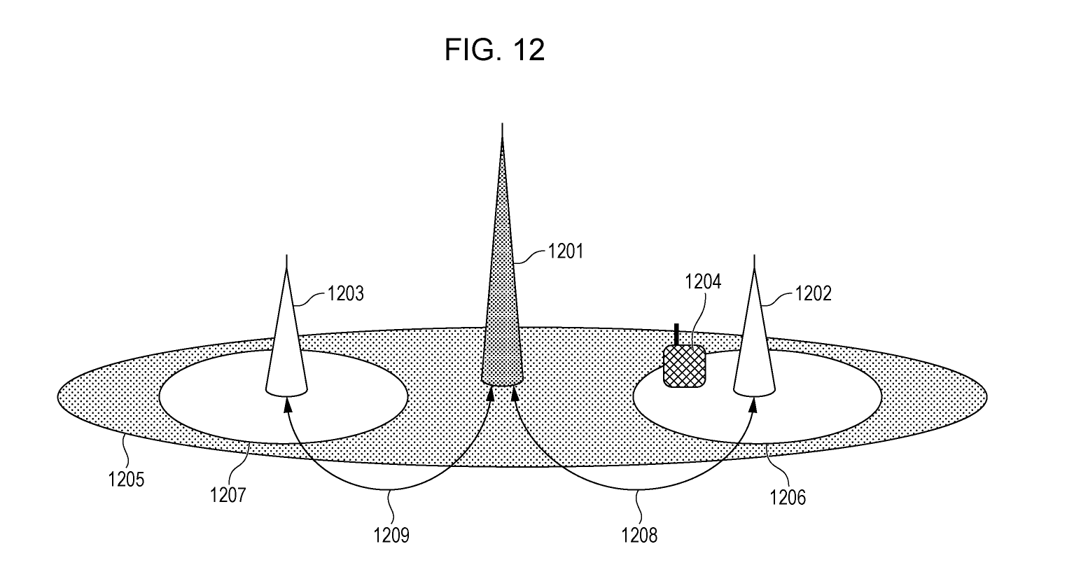

The following describes another method regarding the transmission format described in step 608 of FIG. 6. The power difference information generated in step 603 of FIG. 6 can be subsampled and decimated. Specifically, the power difference information is subsampled in accordance with feedback information different from the power difference information generated by the feedback information generation unit 310. For example, the number of subsampled bits of the power difference information may be changed in accordance with the rank information. FIG. 9 is a diagram illustrating an example of the power difference information to be subsampled in accordance with the rank information. In the example illustrated in FIG. 9, as the rank represented by the rank information increases, the number of subsampled bits of the power difference information increases. Specifically, in the case where the rank is 1 or 2, the power difference information is not subsampled and is two-bit information. In the case where the rank is 3 or 4, 0 and 3 are subsampled and the power difference information becomes one-bit information. In the case where the rank is any of 5 to 8, 0, 1, and 3 are subsampled and the power difference information becomes zero-bit information. Accordingly, in the case where the rank is any of 5 to 8, the power difference information is uniquely decided. As a result, the terminal 104 is no longer required to make a notification of the power difference information as the feedback information. Note that the power difference information may be subsampled in accordance with various pieces of feedback information, the number of transmit antenna ports, and/or configured channel state information reference signals. For example, the power difference information can be subsampled in accordance with the precoding matrix information, the first precoding matrix information, the second precoding matrix information, the channel quality information, and so forth. In this way, as a result of the power difference information being subsampled, the number of bits (overhead) of feedback information can be reduced.

Other than the method for generating the power difference information as independent feedback information, a method for generating one piece of feedback information by combining (jointly coding) the power difference information generated in step 603 of FIG. 6 with other feedback information can be used. Specifically, the power difference information is jointly coded with feedback information different from the power difference information generated by the feedback information generation unit 310. Combining a plurality of pieces of feedback information so as to generate (define) one piece of feedback information is also referred to as “joint coding”. FIG. 10 is a diagram illustrating an example of feedback information in which rank information and power difference information are jointly coded. The feedback information illustrated in FIG. 10 is five-bit information. An index illustrated in FIG. 10 is presented as feedback information in which the rank information and the power difference information are jointly coded. Further, some or all pieces of feedback information to be jointly coded can be subsampled. In the feedback information illustrated in FIG. 10, the number of to-be-subsampled bits of the power difference information changes depending on the rank information. Also, the feedback information illustrated in FIG. 10 uses indices 0 to 17. Indices 18 to 31 are not to be used and can be reserved for future extension. The feedback information illustrated in FIG. 10 may be generated as the rank information. Note that the power difference information can be jointly coded with various pieces of feedback information, the number of transmit antenna ports, and/or configured channel state information reference signals. For example, the power difference information can be jointly coded with the precoding matrix information, the first precoding matrix information, the second precoding matrix information, the channel quality information, and so forth. As a result of the power difference information being jointly coded with other feedback information in this way, the number of bits (overhead) of the feedback information can be reduced and the number of kinds of feedback information can be reduced.

Alternatively, the terminal 104 may generate information indicating whether or not it is capable of generating the power difference information as the feedback information, and notify the transmission point 101 and/or the transmission point 102 of the information. The information indicating whether or not the terminal 104 is capable of generating the power difference information can be included in terminal capability information (UE capability) or FGI (Feature Group Indicator) which the transmission point is notified of via higher-layer signaling. Here, the terminal capability information is information used by the terminal to notify a base station or a communication system of its supporting capabilities and functions, and includes, for example, the maximum number of data signal bits transmittable per unit time, the maximum rank used in the downlink, and so forth. Also, the FGI is information indicating whether or not the terminal has implemented or tested certain functions, and the certain functions include, for example, some of the reporting modes and so forth. The FGI can be included in the terminal capability information and be notified. In this way, the terminal not supporting a function of generating the power difference information as the feedback information can communicate with a transmission point (base station) capable of receiving the power difference information as the feedback information.

The embodiment has been described above using resource elements or resource blocks as units in which the data channel, the control channel, the PDSCH, the PDCCH, and the reference signals are mapped and using subframes or radio frames as units of transmission in the time direction; however, the units are not limited to these units. Similar advantages can be obtained by using a region constituted by a given frequency and time and by using time units instead of these units. In the above embodiment, modulation using the precoded RS has been described and the use of a port equivalent to an MIMO layer as a port corresponding to the precoded RS has been described; however, the configuration is not limited to this one. Other than this, similar advantages can be obtained by applying the present invention to ports corresponding to reference signals different from each other. For example, an unprecoded RS can be used instead of the precoded RS and a port equivalent to an output end of precoding processing or a port equivalent to a physical antenna (or a combination of physical antennas) can be used.

Programs that operate in the transmission point 101, the transmission point 102, and the terminal 104 according to the embodiment are programs for controlling a CPU or the like so as to implement the functions of the embodiment (programs for causing a computer to function). Information handled by these apparatuses are temporarily accumulated in a RAM during processing, and then stored in various kinds of ROMs or an HDD, read out, modified, and written by the CPU if necessary. A recording medium storing the programs may be a semiconductor medium (for example, a ROM, nonvolatile memory card, or the like), an optical recording medium (for example, a DVD, MO, MD, CD, BD, or the like), a magnetic recording medium (for example, a magnetic tape, flexible disk, or the like), or the like. The above-described functions of the embodiment may be implemented not only through execution of a loaded program but also through performance of processing in cooperation with the operating system, another application program, or the like based on instructions of the program.

In the case of distributing the programs in the market, the programs may be distributed with being stored on a portable recording medium or may be transferred to a server computer connected via a network, such as the Internet. In this case, a storage device included in the server computer is also encompassed by the present invention. Part or the entirety of the transmission point 101, the transmission point 102, and the terminal 104 according to the above-described embodiment may be typically implemented as an LSI which is an integrated circuit. Functional blocks of the transmission point 101, the transmission point 102, and the terminal 104 may be individually formed as chips or some or all of them may be integrated into a chip. A method for integration may be a dedicated circuit or a general-purpose processor, as well as an LSI. In a case where the progress of semiconductor technologies produces an integration technology which replaces an LSI, an integrated circuit based on the technology can be used.

The embodiment of this invention has been described in detail above with reference to the drawings. Specific configurations are not limited to this embodiment, and design modifications or the like within a scope that does not deviate from the gist of this invention are also included in the claims. Also, various modifications may occur to the present invention within the scope of claims, and embodiments resulting from these modifications are also within the technical scope of the present invention. Configurations in which an element described in the above embodiment is replaced with another element that provides the similar advantages are also within the technical scope of the present invention.

### INDUSTRIAL APPLICABILITY

The present invention is preferably used for a wireless base station apparatus, a wireless terminal apparatus, a wireless communication system, and a wireless communication method.

### REFERENCE SIGNS LIST

101, 102, 1201-1203 transmission point; 103, 1208, 1209 line; 104, 1110, 1204 terminal; 105, 106, 1120 downlink; 107, 1121 uplink; 110-117 transmit antenna port; 201, 307 higher layer; 202 shared channel generation unit; 203 terminal-specific reference signal multiplexing unit; 204 precoding unit; 205 control channel generation unit; 206 cell-specific reference signal multiplexing unit; 207 transmit signal generation unit; 208, 311 transmission unit; 209, 312, 1103, 1114 transmit antenna; 210, 301, 1104, 1111 receive antenna; 211, 302 reception unit; 212, 1105 feedback information processing unit; 303 receive signal processing unit; 304 channel estimation unit; 305 control channel processing unit; 306 shared channel processing unit; 310, 1113 feedback information generation unit; 1100 base station; 1101 adaptive control unit; 1102 multiplexing unit; 1112 demultiplexing unit; 1205-1207 coverage.

1-15. (canceled)

16. A terminal apparatus configured to communicate with a base station apparatus including a plurality of transmit antenna ports, comprising:
a channel estimation unit configured to estimate a channel state based on a channel state information reference signal associated with the plurality of transmit antenna ports; and
a feedback information generation unit configured to generate, based on the channel state, channel state information corresponding to a difference between powers for groups of transmit antenna ports that are some of the plurality of transmit antenna ports.

17. The terminal apparatus according to claim 16, wherein the transmit antenna port for each of the groups corresponds to a transmit antenna port predefined from among the plurality of transmit antenna ports.

18. The terminal apparatus according to claim 16, wherein the transmit antenna port for each of the groups corresponds to a transmit antenna port configured by the base station apparatus from among the plurality of transmit antenna ports.

19. The terminal apparatus according to claim 16, wherein the plurality of transmit antenna ports are associated with the channel state information reference signal that is configured based on one piece of control information for the channel state information reference signal.

20. The terminal apparatus according to claim 16, wherein the plurality of transmit antenna ports are associated with the channel state information reference signal that is configured based on a plurality of pieces of control information for the channel state information reference signal.

21. The terminal apparatus according to claim 20, wherein the transmit antenna port for each of the groups corresponds to a transmit antenna port associated with the channel state information reference signal that is configured based on one piece of control information for the channel state information reference signal.

22. The terminal apparatus according to claim 16, wherein the feedback information generation unit is configured to generate the channel state information corresponding to a difference between powers for the groups of transmit antenna ports arranged at a spatially same location.

23. The terminal apparatus according to claim 16, wherein the channel state information is subsampled in accordance with channel state information different from the channel state information corresponding to the difference.

24. The terminal apparatus according to claim 16, wherein the channel state information is jointly coded with channel state information different from the channel state information corresponding to the difference.

25. A base station apparatus including a plurality of transmit antenna ports and configured to communicate with a terminal apparatus, comprising:
transmission unit configured to transmit a channel state information reference signal associated with the plurality of transmit antenna ports; and
a feedback information processing unit configured to process channel state information from the terminal apparatus, wherein
the channel state information is generated, based on a channel state that is estimated using the channel state information reference signal, the channel state information corresponding to a difference between powers for groups of transmit antenna ports that are some of the plurality of transmit antenna ports.

26. The base station apparatus according to claim 25, wherein the channel state information reference signal is transmitted from the transmit antenna ports of a plurality of transmission points arranged at spatially different locations.

27. A communication method for a terminal apparatus configured to communicate with a base station apparatus including a plurality of transmit antenna ports, comprising:
a step of estimating a channel state based on a channel state information reference signal associated with the plurality of transmit antenna ports; and
a step of generating, based on the channel state, channel state information corresponding to a difference between powers for groups of transmit antenna ports that are some of the plurality of transmit antenna ports.
